(19) United States
(12) Patent Application Publication
(10) Pub. No.: US 2026/0214113 A1
(43) Pub. Date: Jul. 23, 2026

(54) CYBERSECURITY TECHNIQUES FOR SCANNING A COMPUTING ENVIRONMENT

(71) Applicant: Rapid7, Inc., Boston, MA (US)

(72) Inventor: Paul Miseiko, Toronto (CA)

(21) Appl. No.: 19/035,611

(22) Filed: Jan. 23, 2025

(51) Int. Cl. H04L 9/40

(52) U.S. Cl. CPC H04L 63/1433; H04L 63/0281

(57) ABSTRACT

Some embodiments provide a system for performing scanning of a computing environment comprising a plurality of computing assets. The system comprises a local device in the computing environment and a cloud-based security system remote to the computing environment. The local device performs network mapping operations on computing assets in the computing environment to obtain network mapping data and transmits the network mapping data to the cloud-based security system in support of scanning to be performed by the cloud-based security system. The local device further transmits data between the cloud-based security system and the computing assets. The cloud-based security system uses one or more cloud-based scan engines to perform scanning operations using the network mapping data by communicating with the computing assets through the local device.

### BACKGROUND

Cybersecurity is important in organizations which manage computing assets. To ensure that assets are protected, organizations may put in place policies. The policies may govern, for example, applications that can be executed, resources that can be accessed, or connections that can be maintained. Additionally, an organization may wish to know which assets are constituents of a computing network, as well as how such devices interconnect and communicate with devices inside and outside the organization's network.

However, even once such policies have been established and the devices in a computing environment and interconnectedness thereof have been understood, it is important to monitor computing assets in the computing environment. Monitoring may be performed regularly to ensure continued compliance with policies (e.g. when new software applications are added, when new updates are made available, or when policies are changed) and identify vulnerabilities in the computing environment. This is an important aspect of cybersecurity to protect computing assets in the computing environment. The computing environment may be regularly scanned to identify cybersecurity issues that may exist in the computing environment (e.g., violation of a policy and/or a cybersecurity vulnerability).

### SUMMARY

In some embodiments, the techniques described herein relate to a system for performing scanning of a computing environment including a plurality of computing assets, the system including: a first computing device in the computing environment, the first computing device configured to use a first scan engine support module to perform: performing, using a first network mapping module, a first set of one or more network mapping operations on a first set of the plurality of computing assets in the computing environment to obtain a first set of network mapping data; transmitting, to a cloud-based security system remote to the computing environment, the first set of network mapping data in support of scanning to be performed by the cloud-based security system; and transmitting data between the cloud-based security system and the first set of computing assets in the computing environment; and the cloud-based security system remote to the computing environment, the cloud-based security system configured to use a first set of one or more cloud-based scan engines to perform scanning of the computing environment by: causing the first computing device to perform the first set of one or more network mapping operations on the first set of computing assets in the computing environment to obtain the first set of network mapping data; and performing, using the first set of network mapping data, a first set of one or more scanning operations to identify a first cybersecurity issue or finding, the performing including communicating with the first set of computing assets in the computing environment through the first computing device.

In some embodiments, the techniques described herein relate to a method for performing scanning of a computing environment including a plurality of computing assets, the method including: using, by a first computing device in the computing environment, a first scan engine support module to perform: performing, using a first network mapping module, a first set of one or more network mapping operations on a first set of the plurality of computing assets in the computing environment to obtain a first set of network mapping data; transmitting, to a cloud-based security system remote to the computing environment, the first set of network mapping data in support of scanning to be performed by the cloud-based security system; and transmitting data between the cloud-based security system and the first set of computing assets in the computing environment; and using, by the cloud-based security system remote to the computing environment, a first set of one or more cloud-based scan engines to perform scanning of the computing environment by: causing the first computing device to perform the first set of one or more network mapping operations on the first set of computing assets in the computing environment to obtain the first set of network mapping data; and performing, using the first set of network mapping data, a first set of one or more scanning operations to identify a first cybersecurity issue or finding, the performing including communicating with the first set of computing assets in the computing environment through the first computing device.

In some embodiments, the techniques described herein relate to at least one non-transitory computer-readable storage medium storing: a first set of instructions that, when executed by a first computing device in a computing environment including a plurality of computing assets, cause the first computing device to perform: performing, using a first network mapping module, a first set of one or more network mapping operations on a first set of the plurality of computing assets in the computing environment to obtain a first set of network mapping data; transmitting, to a cloud-based security system remote to the computing environment, the first set of network mapping data in support of scanning to be performed by the cloud-based security system; and transmitting data between the cloud-based security system and the first set of computing assets in the computing environment; and a second set of instructions that, when executed by the cloud-based security system remote to the computing environment. cause the cloud-based security system to use a first set of one or more cloud-based scan engines to perform scanning of the computing environment by: causing the first computing device to perform the first set of one or more network mapping operations on the first set of computing assets in the computing environment to obtain the first set of network mapping data; and performing, using the first set of network mapping data, a first set of one or more scanning operations to identify a first cybersecurity issue or finding, the performing including communicating with the first set of computing assets in the computing environment through the first computing device.

### BRIEF DESCRIPTION OF DRAWINGS

FIG. 1 is a diagram of a scanning system comprising local devices and a cloud-based security system according to some embodiments of the technology disclosed herein.

FIG. 2 illustrates communication between the cloud-based security system and the local devices of FIG. 1 using transmission control protocol (TCP) acceleration, according to some embodiments of the technology disclosed herein.

FIG. 3 is a flow chart illustrating a process for scanning a computing environment, according to some embodiments of the technology disclosed herein.

FIG. 4 is a block diagram of an exemplary computing device that may be specially configured to implement some embodiments of the technology described herein.

### DETAILED DESCRIPTION

Described herein is a system for scanning a computing environment for cybersecurity issues and/or findings. The system comprises a cloud-based security system remote to the computing environment to be scanned and one or more devices in the computing environment to be scanned (also referred to as local device(s), in the sense that they are “local” to the computing environment being scanned). The cloud-based security system uses the local device(s) to scan computing assets in the computing environment for cybersecurity issues (e.g., cybersecurity vulnerabilities, non-compliance with cybersecurity policies, and/or other cybersecurity issues) and/or findings (e.g., fingerprinting, installed software applications, users with access, and/or other findings).

Conventional technology for scanning computing environments uses either: (1) local scan engines executed by one or more computing devices in the computing environment that scan the computing environment, or (2) cloud-based scan engines that scan a computing environment by communicating with computing assets of the computing environment via a network, such as the Internet. The inventors have recognized disadvantages in both types of conventional scanning technologies.

The first type of conventional scanning technology requires the computing environment to host local scan engines, which requires additional computing resources to manage and execute the local scan engines. Further, the local scan engines may not scale effectively over time because the amount and complexity of scanning may increase (e.g., due to an increase in the number of computing assets, addition of software applications, and/or addition of cybersecurity issues that need to be identified). Thus, the performance of local scan engines may degrade or otherwise need more computing resources to scale up their processing capacity.

The second type of conventional scanning technology does not use computing resources of the computing environment (e.g., because the scan engines are executed by a separate cloud-based system). However, scanning efficiency is limited by the latency of network communication between the cloud-based scan engines and the computing assets being scanned. Cloud-based scan engines need to send and receive network packets to computing assets of a computing environment through the Internet. The network latency in communication between the cloud-based scan engines and the computing assets increases the amount of time required to perform the network mapping operations. This is particularly the case for network mapping operations that need to be performed to scan a computing environment for cybersecurity issues and/or findings. Network mapping operations involve sending a large number of network packets to computing assets and analyzing responses to the network packets. Network mapping operations may include asset discovery (e.g., identifying hosts in a computing environment), service discovery (e.g., identifying one or more ports of hosts in the computing environment), and/or other operations. Furthermore, the cloud-based scan engines need to pierce a computing environment's firewall to communicate with the computing assets. This opens the computing environment to the risk of a malicious entity exploiting connections through the firewall to gain unauthorized access to computing assets in the computing environment.

The present disclosure describes technology that addresses the above-described challenges in conventional scanning technology. Described herein are embodiments of a hybrid cybersecurity scanning system that includes both one or more cloud-based components remote from the computing environment being scanned and one or more components part of the computing environment being scanned to scan the computing environment for cybersecurity issues (e.g., vulnerabilities, non-compliance with policies, and/or other cybersecurity issues) and/or findings. The cloud-based component(s) execute cloud-based scan engines that do not use resources of the computing environment. The cloud-based component(s) can scale the cloud-based scan engines up or down as needed for scanning. The component(s) that are part of the computing environment perform network mapping operations by communicating with computing assets of the computing environment through a local network (as opposed to through the Internet) and transmit results of the network mapping operations (e.g., an indication of discovered assets and/or services) to the cloud-based scan engines. The hybrid system reduces the amount of network communication between the cloud-based component(s) and the computing assets, thereby mitigating the effect of network latency while using a limited amount of the computing environment's computing resources. The cloud-based scan engines use the results of the network mapping operations to perform scanning operations such as fingerprinting, vulnerability detection, and policy-compliance assessment. The cloud-based scan engines may further communicate with the computing assets through the local device to perform scanning operations.

Accordingly, some embodiments provide for a system for scanning a computing environment comprising multiple computing assets. The system comprises a local scanning device in the computing environment and a cloud-based security system remote to the computing environment. The local scanning device may be configured to perform network mapping operations on the computing assets (e.g., asset discovery and/or service discovery), transmit resulting network mapping information to the cloud-based security system, and transmit (e.g., bidirectionally relay) data between the cloud-based security system and the computing assets of the computing environment. The cloud-based security system uses one or more cloud-based scan engines to direct the network mapping operations of the local computing device and to perform scanning operations. The cloud-based scan engine(s) communicate with computing assets of the computing environment through the local scanning device. In some embodiments, the cloud-based security system may use the cloud-based scan engine(s) to perform scanning operation(s) to identify a cybersecurity issue or finding.

The inventors further recognized that the efficiency of a hybrid scanning system can be improved by leveraging TCP acceleration to reduce the volume of Internet communications between the cloud-based engine and the local device. TCP acceleration consolidates multiple TCP communications into a single Internet transmission. This reduces the number of network packets that need to be transmitted between cloud-based engine(s) and computing assets thereby mitigating the effect of network latency on scanning. Further, local TCP acceleration employs local TCP accelerated proxies that respond with acknowledgments as soon as they receive a transmission from an associated device, thus enabling the transmitting device to continue processing without needing to wait for the receipt of an acknowledgement message through the network.

Accordingly, some embodiments establish an accelerated TCP connection between cloud-based engine(s) and a local device. A set of cloud-based engine(s) and a local device each may have a respective TCP accelerated proxy. Communications are transmitted between the set of cloud-based engine(s) and the local device through the TCP accelerated proxies. The TCP accelerated proxies may, for example, consolidate multiple communications and/or provide acknowledgement messages to make scanning more efficient.

Some embodiments provide a system for performing scanning of a computing environment comprising a plurality of computing assets (e.g., distributed set of computer systems, a network of client(s) and server(s), a networked set of computing devices, a cloud computing environment, a cluster, and/or another computing environment). The system comprises: a first computing device in the computing environment, the first computing device configured to use a first scan engine support module to perform: performing, using a first network mapping module, a first set of one or more network mapping operations (e.g., asset discovery and/or service discovery operation(s)) on a first set of the plurality of computing assets in the computing environment to obtain a first set of network mapping data; transmitting, to a cloud-based security system (e.g., via the Internet) remote to the computing environment, the first set of network mapping data in support of scanning to be performed by the cloud-based security system; and transmitting data between the cloud-based security system and the first set of computing assets in the computing environment. The cloud-based security system may be configured to use a first set of one or more cloud-based scan engines to perform scanning of the computing environment by: causing the first computing device to perform the first set of one or more network mapping operations on the first set of computing assets in the computing environment to obtain the first set of network mapping data; and performing, using the first set of network mapping data, a first set of one or more scanning operations to identify a first cybersecurity issue or finding (e.g., determining whether a first vulnerability is present in the first set of computing assets and/or determining whether the computing environment fails to comply with a policy), the performing comprising communicating with the first set of computing assets in the computing environment through the first computing device.

In some embodiments, the first computing device and/or the cloud-based security system may be configured to perform additional processing based on an identified cybersecurity issue or finding. For example, the first computing device and/or the cloud-based security system may mitigate an identified cybersecurity issue or respond to a finding. This mitigation of the identified or responding to the finding may include, for example, denying a computing asset's access to a resource or application, causing the download or installation of software (e.g., a security patch) which impacts the functioning of computing assets, adjusting the security configurations of the computing environment, conducting additional scanning operations, generating a report of findings, and/or other operation(s). In some embodiments, mitigation and/or response operation(s) may be performed by the cloud-based security system using the first computing device. For example, the cloud-based security system may instruct the first computing device to perform the mitigation and/or response operation(s). In some embodiments, mitigation and/or response operation(s) may be performed by the cloud-based security system by communicating directly with communicating assets through the first computing device.

In some embodiments, the first computing device is further configured to use the first scan engine support module to perform: establishing a connection through which the first scan engine support module can communicate with the first set of one or more cloud-based scan engines, wherein the transmitting of the first set of network mapping data is performed using the connection. In some embodiments, causing the first computing device to perform the first set of one or more network mapping operations on the first set of computing assets in the computing environment comprises: transmitting, to the first network mapping module through the connection, at least one command, wherein the at least one command causes the network mapping module to: perform the first set of one or more network mapping operations on the first set of computing assets in the computing environment to obtain the first set of network mapping data; and transmit, to the first set of one or more cloud-based scan engines, the first set of network mapping data in support of scanning to be performed by the cloud-based security system. In some embodiments, transmitting, to the first network mapping module, the at least one command comprises transmitting a plurality of commands; and the first set of one or more cloud-based scan engines is configured to receive the first set of network mapping data responsive to the plurality of commands.

In some embodiments, the first computing device is further configured to use the first scan engine support module to perform: establishing a first TCP accelerated proxy for transmission of data between the first set of computing assets and the first set of one or more cloud-based scan engines, wherein the transmitting of the data between the cloud-based security system and the first set of computing assets is performed using the first TCP accelerated proxy. In some embodiments, establishing the first TCP accelerated proxy comprises: establishing a connection between the first TCP accelerated proxy and a second TCP accelerated proxy associated with the first set of one or more cloud-based scan engines. In some embodiments, communicating with the first set of computing assets in the computing environment through the first computing device comprises: transmitting, through the connection between the first TCP accelerated proxy and the second TCP accelerated proxy, at least one request to the first set of computing assets, and obtaining, through the connection between the first TCP accelerated proxy and the second TCP accelerated proxy, data in response to the at least one request.

In some embodiments, the cloud-based security system is further configured to: determine a number of cloud-based scan engines (e.g., based on a number of computing assets in the first set of computing assets) to instantiate to scan the computing environment for the first cybersecurity issue or finding; and instantiate the determined number of cloud-based scan engines as the first set of one or more cloud-based scan engines. In some embodiments, the cloud-based security system is further configured to: after instantiating the determined number of cloud-based scan engines as the first set of one or more cloud-based scan engines: determine that one or more additional computing assets are to be scanned to obtain data; and instantiate at least one additional cloud-based scan engine to be added to the first set when it is determined that the one or more additional computing assets are to be scanned.

Following below are more detailed descriptions of various concepts related to, and embodiments of, hybrid scanning systems. It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

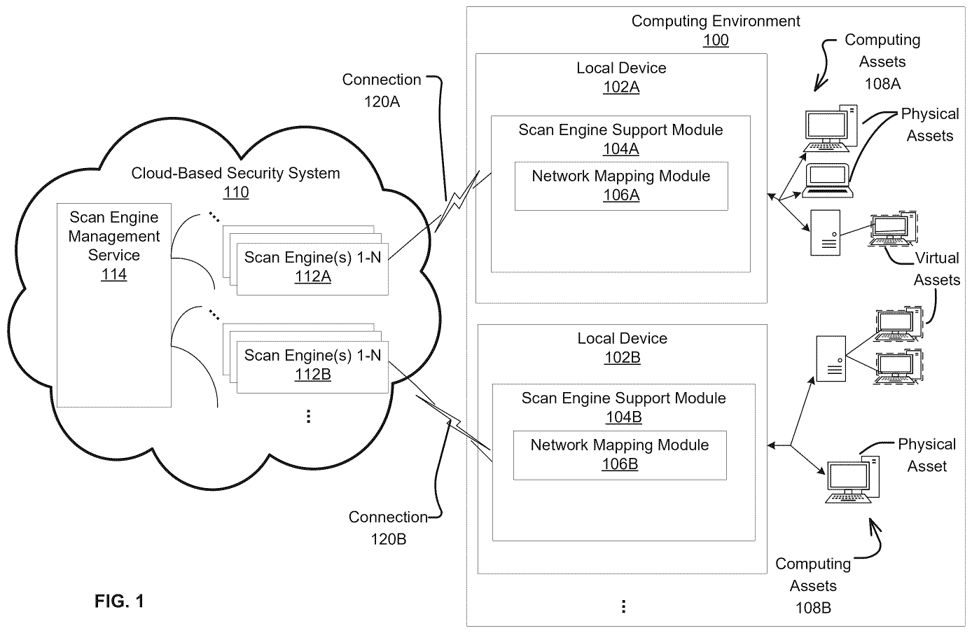

FIG. 1 is a diagram of a scanning system comprising local devices and a cloud-based security system according to some embodiments of the technology disclosed herein. Computing environment 100 may comprise one or more computing assets 108. As shown in FIG. 1, the computing assets 108 may comprise any combination of physical assets and virtual assets, including all physical assets, all virtual assets, or a mix of physical assets and virtual assets. Physical assets may include, but are not limited to, devices such as desktop computers, laptop computers, printers, FAX machines, telephones including cellular telephones, servers, CCTV cameras, and so forth. Virtual assets may include, but are not limited to, virtual machines, cloud instances, containers, and so forth. Virtual assets may be hosted by one or more physical devices (e.g., servers or other computing devices).

Computing environment 100 includes local devices 102A, 102B, each of which is configured to communicate with a set of computing assets. Local device 102A is configured to communicate with computing assets 108A and local device 102B is configured to communicate with computing assets 108B. While FIG. 1 shows two local devices 102A and 102B, the technology is not limited in this respect. A computing environment 100 may, for example, have one local device, or may have three or more local devices. In some embodiments, the number of local devices may be decided by, for example, a cybersecurity engineer of the computing environment 100 based on considerations such as cost, desired performance, and the number of computing assets 108 in the computing environment 100. In some embodiments, each local device may be configured to communicate with any number of computing assets.

As shown in FIG. 1, each local device comprises a respective set of software modules. A local device may be configured to execute its software modules using one or more processors of the local device. Local device 102A includes scan engine support module 104A which includes network mapping module 106A and local device 102B includes scan engine support module 104B which includes network mapping module 106B. In some embodiments, a local device may be configured to use its network mapping module to perform one or more network mapping operations. Performing network mapping operations (e.g., asset discovery and/or service discovery) may involve, for example, sending a ping/pong to check connection health, starting asset and/or service discovery, polling asset and/or service discovery state, polling asset and/or service discovery results, pausing asset and/or service discovery, and stopping asset and/or service discovery. The local device may be configured to perform network mapping operations by using a network scanning tool such as Nmap and/or another tool.

In some embodiments, a scan engine support module of a local device may be configured to communicate via a connection with a respective set of one or more cloud-based scan engines hosted by the cloud-based security system 110. In the example of FIG. 1, scan engine support module 104A is configured to communicate with scan engine(s) 112A using connection 120A and scan engine support module 104B is configured to communicate with scan engine(s) 112B using connection 120B. A scan engine support module may be configured to communicate with a respective set of scan engine(s) through a communication network (e.g., the Internet). In some embodiments, the scan engine support module may be configured to utilize a protocol or combination of multiple protocols to communicate through the communication network. For example, the scan engine support module may be configured to communicate using the TCP and/or the user datagram protocol (UDP) to communicate with the set of scan engine(s).

In some embodiments, the cloud-based security system 110 is configured to execute scan engines. In the example of FIG. 1, the cloud-based security system 110 is configured to execute a set of one or more scan engines 112A and a set of one or more scan engines 112B. The set of scan engine(s) 112A is associated with the local device 102A and the set of scan engine(s) 112B is associated with the local device 102B. Each of the sets of scan engine(s) 112A, 112B may be supported by its associated local device. For example, a set of scan engine(s) may cause an associated local device to perform network mapping operations. As another example, a set of scan engine(s) may communicate with computing assets in the computing environment 100 through an associated local device. The set of scan engine(s) 112A may communicate with computing assets 108A through the local device 102A and the set of scan engine(s) 112B may communicate with computing assets 108B through the local device 102B.

While FIG. 1 shows two sets of scan engines associated with separate local devices, the technology is not limited in this respect. One scan engine may be associated with more than one local device and one local device may be associated with more than one scan engine. The number of scan engines associated with a given local device may be adjusted during operation of the cloud-based scan engine 100. This ability to adjust the number of scan engines supporting and conducting scan operations, combined with the capability of local devices to associate with a range of computing assets, provides the benefits of system scalability such as were discussed above.

As shown in the example of FIG. 1, the cloud-based security system 110 may comprise a scan engine management service 114. The scan engine management service 114 may, as mentioned above, “spool up” or “spin down” the number of scan engines which are associated with the local devices of a given computing environment 100. In some embodiments, the scan engine management service 114 may be configured to determine a number of cloud-based scan engines to instantiate for scanning a set of computing assets (e.g., computing assets 108A or computing assets 108B), and instantiate the number of cloud-based scan engines (e.g., as the set of scan engine(s) 112A or as the set of scan engine(s) 112B). For example, the scan engine management service 114 may be configured to determine the number of cloud-based scan engines to instantiate based on a number of computing assets in the set of computing assets to be scanned. In some embodiments, the scan engine management service 114 may be configured to adjust the number of cloud-based scan engines instantiated for scanning the set of computing assets. For example, the scan engine management service 114 may increase/decrease the number of cloud-based scan engines as the amount of scanning operations that need to be performed increases/decreases. As another example, the scan engine management service 114 may increase/decrease the number of cloud-based scan engines as the number of computing assets that need to be scanned increases/decreases. In some embodiments, the scan engine management service 114 may be configured to dynamically adjust the number of cloud-based scan engines allocated to a set of computing assets during scanning. Thus, the number of cloud-based scan engines may change based on the processing demands (e.g., based on scanning operations to be performed, the number of computing assets, and/or a number of computing environments for which scanning is to be performed). In some embodiments, the scan engine management service 114 may be configured to perform load balancing, multiplexing, authentication, authorization, identification of computing environment 100, and pairing of local devices with scan engines.

In some embodiments, a scan engine may be configured to perform one or more scan operations. Example scan operations that a scan engine may be configured to perform may include, but not be limited to, opening a TCP connection, opening a UDP connection, opening a connection for another protocol, polling the state of a connection via a unique identifier, writing bytes to a connection via a unique identifier, reading bytes from a connection via a unique identifier, or closing a connection via a unique identifier. In some embodiments, a scan engine may be configured to perform scanning operations by communicating with one or more computing assets through a local device. In other words, the scan engine may be configured to use the local device as a proxy through which the scan engine communicates with the computing asset(s). For example, the scan engine may send a command, over a connection via a communication protocol such as TCP or UDP, to a local device for the local device to create a connection between the local device and a certain computing asset (e.g. such as may have been identified in the command from the scan engine). Thereafter, the local device may handle state-related communications with the computing asset such as handshakes and acknowledgements. In some embodiments, the scan engine may be configured to transmit a request to the computing asset through the local device and receive a response to the request through the local device. For example, the scan engine may transmit one or more requests to the computing asset to collect data that the scan engine may process to detect a cybersecurity vulnerability in the computing environment 100.

In some embodiments, a scan engine may be configured to command a local device to perform one or more operations. For example, the scan engine may command the local device to perform one or more network mapping operations. The local device may be configured to perform the operation(s) in response to one or more commands from the scan engine and may further be configured to send results of performing the operation(s) to the scan engine. The scan engine may be configured to receive results of performing the operation(s) from the local device. For example, the scan engine may receive results of network mapping operations that the local device was commanded to perform.

In some embodiments, a scan engine may be configured to perform one or more scanning operations by processing data obtained from a local device (e.g., results of network mapping operations and/or data from computing assets). Processing data may comprise, for example, comparing obtained data with databases of known security vulnerabilities (e.g. such as may be associated with one or more services, or one or more combinations of services, present on a computing asset), comparing obtained data with cybersecurity policies (e.g. those of the computing environment in which the local device is positioned, or those such as may comprise recommended best practices), analyzing the context (e.g. time obtained compared to time requested, originating computing asset, and so forth) of obtained data, and other such processing and analysis. The scan engine may be configured to process the data to identify one or more cybersecurity issues or findings. For example, cyber security issues may comprise indicia of one or more of the following illustrative but not exhaustive list: the presence of known vulnerabilities (e.g. such as may be stored in a database of hundreds of thousands of known vulnerabilities or more) in services (e.g. software applications and/or accessed Internet resources) utilized by computing assets, insufficient mitigation of risks resulting from present vulnerabilities (e.g. such as may be present in software the use of which cannot be avoided), noncompliance of computing assets with cybersecurity policies, the compromising of authentication credentials, attempted malicious database access (e.g. via SQL injection), cross-site scripting attacks, cross-site request forgeries, security misconfigurations (e.g. wherein the configuration of components of a cybersecurity system inadvertently permits certain action or access), data leaks, data breaches, malware infections, suspicious log-ins or login-attempts, and maliciously-used IP addresses, URLs, domains, or hashes. Findings may comprise indicia of one or more of the following illustrative but not exhaustive list: fingerprints, inventory of installed software applications, user(s) who have access to a system, compliance with a password policy, and/or other findings.

In some embodiments, a scan engine may be configured to transmit, to a local device, instructions to perform actions to mitigate risks associated with identified vulnerability issues. For example, the scan engine may transmit instructions to deny access of a computing asset 108 to a resource or application. As another example, the scan engine may transmit instructions to cause the download or installation of software application update (e.g., a security patch or other update) which impacts the functioning of one or more computing assets (e.g., to protect the computing asset(s) against an identified vulnerability). As another example, a scan engine may transmit instructions to adjust the security configurations of the computing environment 100.

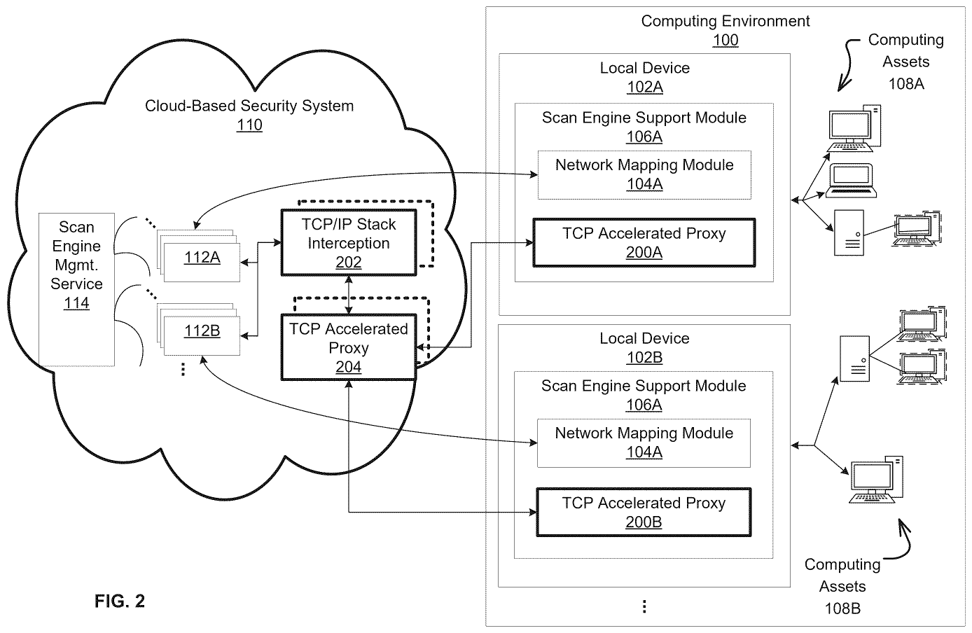

FIG. 2 illustrates communication between the cloud-based security system 110 and the local devices 102A, 102B of FIG. 1 using transmission control protocol (TCP) acceleration, according to some embodiments of the technology disclosed herein. As shown in FIG. 2, the sets of scan engine(s) 112A, 112B communicate with respective local devices 102A, 102B through a TCP accelerated proxy 204. Each of the local devices 102A, 102B have respective TCP accelerated proxies 200A, 200B through which they communicate with their respective sets of scan engine(s). Each of the TCP accelerated proxies 200A, 200B may exchange data with the TCP accelerated proxy 204.

As shown in FIG. 2, each of the local devices of the computing environment 100 may comprise a TCP accelerated proxy. For example, local device 102A may comprise a TCP accelerated proxy 200A and local device 102B may comprise a TCP accelerated proxy 200B. The TCP accelerated proxies of local devices may communicate with the associated local device, with the computing assets associated with the local device (e.g. via the local device), and with the TCP accelerated proxy 204 of the cloud-based security system 110.

In some embodiments and as described above, the inclusion of TCP accelerated proxies enables low-latency communication between the local devices and the scan engines of the cloud-based security system 110. As was also previously described, it is advantageous that computationally lightweight operations such as asset discovery and service discovery be performed by a local device rather than by a cloud-based scan engine 112 to reduce the volume of Internet communications such as may impact the performance of the computing environment 100. However, it may nonetheless be desirable for the cloud-based security system 110 to receive the results of such a network mapping, to communicate with the computing assets 108 via the local device 102, or to otherwise operate as requiring communication between scan engines 112 and local devices 102.

In some embodiments, a TCP accelerated proxy (e.g., TCP accelerated proxy 200A, 200B or TCP accelerated proxy 204) may be configured inside a network processor (e.g., inside a network interface device). The TCP accelerated proxy may thus terminate TCP connections inside the network processor. A TCP accelerated proxy may be configured to buffer communicates from a sender. In some embodiments, a TCP accelerated proxy may be configured to bundle multiple incoming communications (e.g., incoming network packets). For example, the TCP accelerated proxy may be configured to aggregate multiple incoming packets into a buffer thereby reducing the number of packets that need to be processed. In some embodiments, a TCP accelerated proxy (e.g., TCP accelerated proxy 200A, 200B or TCP accelerated proxy 204) may be configured to bundle output transmissions (e.g., output network packets). For example, the TCP accelerated proxy may be configured to aggregate a set of output transmissions into a smaller number of transmissions (e.g., a single transmission).

In some embodiments, TCP accelerated proxies may be configured for bidirectional communication. While a detailed example has been given with regards to a transmission from a scan engine to a local device, the same principles apply for transmissions from a local device to a scan engine. For example, to summarize at a high level, a local device “believing” itself to be in direct communication with a scan engine may in fact be receiving acknowledgments from a TCP accelerated proxy which consolidates transmissions and takes other actions to optimize Internet communication such that the local device does not suffer drops in performance due to a high round-trip time between a scan engine and elements of the computing environment 100.

As shown in FIG. 2, in some embodiments, the cloud-based security system 110 may comprise a TCP/IP stack interception 202 which serves to redirect certain communications from scanning engines using a TCP acceleration protocol. The TCP/IP stack interception 202 may be configured to intercept TCP messages from cloud-based scan engine(s) addressed to a local device in the computing environment and transmit them through the TCP accelerated proxy 204. The TCP/IP stack interception 202 may be configured to transmit, to the cloud-based scan engine(s), messages received from a local device through the TCP accelerated proxy 204 (e.g., from a TCP accelerated proxy of the local device). In some embodiments, the TCP/IP stack interception 202 may be configured to set up one or more addresses that a set of cloud-based scan engine(s) transmits data to/from a local device. The TCP/IP stack interception 202 may be configured to intercept messages sent to the one or more addresses and transmit the messages to the local device through the TCP accelerated proxy 204.

The following is a non-limiting example of how this TCP acceleration may function in such a system as that of FIG. 2.

First, before a TCP acceleration system has been established, a set of cloud-based scan engine(s) may communicate directly with a local device, such as is indicated by the arrow between the set of scan engine(s) 112A and the network mapping module 104A of the local device 102A or the array between the set of scan engine(s) 112B and the network mapping module 104B of the local device 102B. This connection may be configured, for example, to set up TCP acceleration proxies. In some embodiments, even after TCP acceleration proxies are established there may be communications which are not transmitted via a TCP accelerated proxy. Accordingly, in some embodiments, a set of scan engine(s) may be configured to communicate with a local device through the TCP accelerated proxy 204 and without the TCP accelerated proxy 204.

After the TCP accelerated proxy 204 has been established in the cloud-based security system 110, a set of scan engine(s) may be configured to initiate a transmission intended for a local device or for a computing asset associated with a local device. The TCP/IP stack interception 202 may be configured to intercept communications from a scan engine directed at certain addresses (e.g. such as may be identified from information associated with the transmission) and redirect the communications through the TCP accelerated proxy 204.

In some embodiments, upon receiving a transmission intercepted by TCP/IP stack interception 202, TCP acceleration proxy 204 may be configured to respond to the transmitting scan engine with an acknowledgment (e.g., an ACK message) immediately-that is, without waiting for confirmation from the actual intended recipient (e.g. a local device or a computing asset) in the computing environment 100. Thus, the set of scan engine(s) may continue processing that depends on the acknowledgement without the network latency required to transmit the data through the Internet and to receive the acknowledgement message.

Thus, the transmitting scan engine receives the acknowledgment expected in response to a successful TCP communication and is thereafter free to proceed to the next transmission without engaging in error handling such as retransmission. The scan engine is not necessarily “aware” that its communication is being proxied.

In some embodiments, the TCP accelerated proxy 204 may be configured to handle transmission to the TCP accelerated proxy of a local device. In some embodiments, the TCP accelerated proxy 204 may be configured to bundle multiple transmissions from the scan engine into a single transmission over the Internet to the TCP accelerated proxy of the local device. The TCP accelerated proxy 204 may conduct other operations to make the transmission of data over the Internet more efficient. In some embodiments, the TCP accelerated proxy 204 may be configured to compress data prior to transmission and transmit the compressed data thereby reducing the amount of data that is transmitted through the Internet. Additionally, should errors (e.g. transmission failure, packets arriving out of order, partial transmission) occur in the transmission from the TCP accelerated proxy 204 of the scan engine to the TCP accelerated proxy of the local device, the TCP accelerated proxy 204 of the scan engine may take remedial action such as retransmission.

Upon receipt of the transmission, a TCP accelerated proxy of a local device (e.g., TCP accelerated proxy 200A of local device 102A or TCP accelerated proxy 200B of local device 102B) may be configured to send an acknowledgment to the TCP accelerated proxy 204 of the scan engine and to further communicate the transmission to other components of the local device 102. The local device may be configured to use the TCP accelerated proxy to transmit and/or receive data to/from a set of cloud-based scan engine(s). Data may be transmitted through the TCP accelerated proxy 204 and the TCP accelerated proxy of the local device. For example, the connection between the TCP accelerated proxies may be established and maintained for all or a portion of a session in which the set of cloud-based scan engine(s) are scanning the computing environment 100 for cybersecurity issues and/or findings. In some embodiments, a local device may be configured to respond to transmissions received through its TCP accelerated proxy. For example, the local device may forward transmissions received from a set of cloud-based scan engine(s) to one or more computing assets. As another example, the local device may transmit data from computing asset(s) to set of cloud-based scan engine(s) through its TCP accelerated proxy. As another example, the local device may execute one or more commands received from a set of cloud-based scan engine(s) through the local device's TCP accelerated proxy.

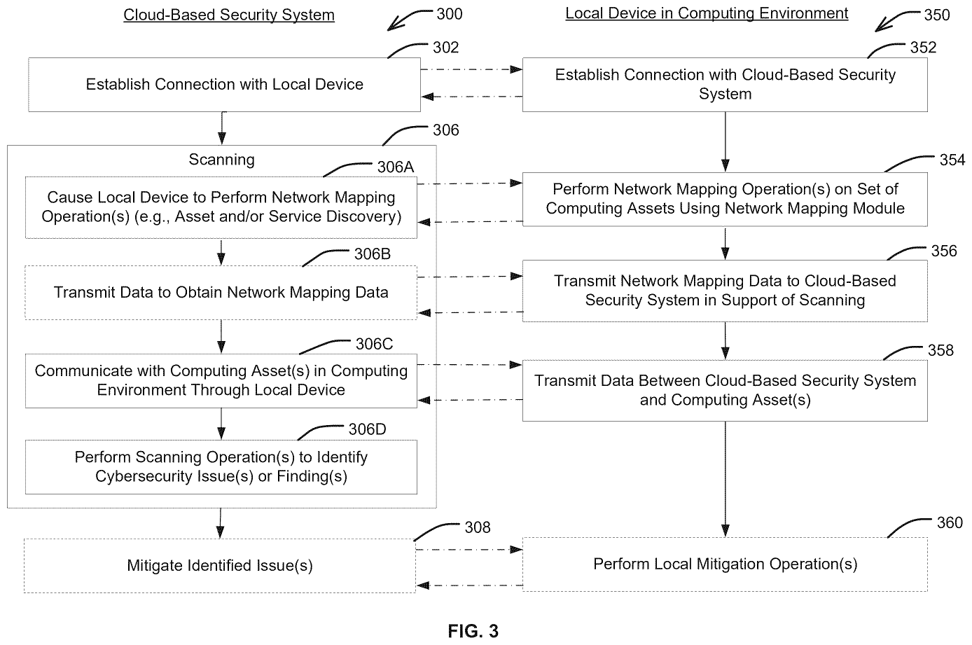

FIG. 3 is a flow chart illustrating a process for scanning a computing environment, according to some embodiments of the technology disclosed herein. Operations which are performed by a cloud-based security system according to some embodiments are presented in the left column 300, whereas operations performed by a local device in a computing environment according to some embodiments are presented in the right column 350. In some embodiments, the process of FIG. 3 may be performed using the cloud-based security system 110 and one of local devices 102A, 102B described herein with reference to FIG. 1 to FIG. 2.

In some embodiments, a scanning system such as disclosed herein may be configured to begin with the cloud-based security system and the local device establishing a connection with one another, such as in complementary steps 302 and 352. As shown by the arrows between blocks 302 and 352, the establishment of the connection may involve communication between the cloud-based security system and the local device. In some embodiments, establishing the connection between the cloud-based security system and the local device may involve opening a TCP and/or UDP connection. In some embodiments, establishing a TCP connection may involve establishing an accelerated TCP connection through which the cloud-based security system can communicate with the local device (e.g., as described herein with reference to FIG. 2). The cloud-based security system and the local device may be configured to communicate, at least in part, through the accelerated TCP connection.

In some embodiments, at block 302, a set of cloud-based scan engine(s) of the cloud-based security system may be configured to establish a connection with the local device. For example, the set of cloud-based scan engine(s) may transmit a connection request (e.g., using authentication credentials) to the local device and the local device may accept the connection request (e.g., after authentication of credentials). In some embodiments, the set of cloud-based scan engine(s) may be provided a unique identifier of the local device (e.g., by scan engine management service 114) and establish a connection with the local device using the unique identifier. In some embodiments, the set of cloud-based scan engine(s) may be configured to write data to the connection and/or read data from the connection via a unique identifier of the local device.

In some embodiments, at block 352, the local device may be configured to receive a connection request from the cloud-based security system. The local device may be configured to authenticate the request (e.g., based on credentials provided in the request). The local device may be configured to establish a connection with the set of cloud-based scan engine(s) when the request is authenticated (e.g., the local device verifies the credentials provided by the set of cloud-based scan engine(s). In some embodiments, the local device may be configured to perform occasional pin/pong to keep a connection session active and refresh any state data (e.g., tables in routers/firewalls between the local device and cloud-based security system).

After establishing the connection with the cloud-based security system at block 352, the local device may be configured to receive data from the cloud-based security system. For example, the local device may accept commands from a set of cloud-based scan engine(s) executed by the cloud-based security system. In some embodiments, the local device may be configured to receive data (e.g., commands) by polling the cloud-based security system for the data (e.g., for commands).

After establishing the connection with the local device at block 302, the cloud-based security system may scan the computing environment at block 306. The scanning at block 306 may include sub-steps 306A, 306B, 306C, 306D. In some embodiments, the cloud-based security system may be configured to scan the computing environment by using as set of one or more cloud-based scan engines to perform scanning (e.g., as described herein with reference to FIG. 1).

At block 306A, the cloud-based security system causes the local device to perform network mapping operations(s) (for example, as may comprise asset and/or service discovery) in step 306A. For example, the cloud-based security system may cause the local device to begin performing asset discovery and/or service discovery (e.g., using a network mapping module of the local device). In some embodiments, the cloud-based security system may be configured to cause the local device to perform network mapping operation(s) by transmitting one or more commands. For example, the cloud-based security system may transmit a single command to initiate performance of the network mapping operation(s) by the local device. As another example, the cloud-based security system may transmit multiple commands to the local device to instruct the local device in performing the network mapping operations. The cloud-based security system may transmit commands and process responses to the commands received from the local device.

In some embodiments, the cloud-based security system may be configured to poll the local device for a network mapping operation state (e.g., an asset discovery state and/or a service discovery state). In some embodiments, the cloud-based security system may be configured to poll the local device for network mapping operation results (e.g., asset discovery results, service discovery results, and/or results of other network mapping operations). In some embodiments, the cloud-based security system may be configured to command the local device to pause and/or stop a network mapping operation.

At block 354, the local device performs network mapping operation(s) (e.g., asset discovery, service discovery, and/or other network mapping operations) using a network mapping module of the local device (e.g., network mapping module 104A or 104B described herein with reference to FIG. 1). In some embodiments, the local device may be configured to perform the network mapping operation(s) in response to one or more commands from the cloud-based security system (e.g., a command to initiate performance of the network mapping operation(s) and/or multiple commands that guide the local device through performance of the network mapping operation(s)).

In some embodiments, the local device may be configured to perform various network mapping operations. For example, the local device may perform asset discovery (e.g., a UDP scan, an internet control message protocol (ICMP) scan, an address resolution protocol (ARP) scan, or another type of asset discovery). As another example, the local device may perform service discovery (e.g., a TCP SYN scan, a TCP CONNECT scan, a UDP scan, and/or another type of service discovery). The local device may be configured to poll network mapping operation states and/or results. The local device may be configured to pause and/or stop a network mapping operation.

Next, at block 306B, the cloud-based security system may transmit data to obtain the network mapping data (e.g. that was gathered by the local device in step 354). For example, the cloud-based security system may be configured to transmit one or more requests for the network mapping data to the local device. As indicated by the dashed lines of block 306B, in some embodiments, the cloud-based security system may not perform the step at block 306B, In such embodiments, the cloud-based security system may be configured to receive network mapping data from the local device without transmitting data to the local device. For example, the local device may be configured to automatically transmit the data to the cloud-based security system without receiving a request from the cloud-based security system.

At block 356, the local device transmits network mapping data (obtained from performing the network mapping operation(s) at block 354) to the cloud-based security system in support of the cloud-based security system's scanning. In some embodiments, the local device may be configured to transmit the network mapping data in response to a request from the cloud-based security system. In some embodiments, the local device may be configured to automatically transmit the network mapping data to the cloud-bases security system without receiving a request for the network mapping data from the cloud-based security system.

At block 306C, the cloud-based security system communicates with one or more computing assets in the computing environment through the local device. Accordingly, the local device may be configured to transmit and receive data between the cloud-based security system and computing assets in step 358. In some embodiments, a set of cloud-based scan engine(s) may be configured to transmit and receive data to/from the computing assets through the local device. In some embodiments, the cloud-bases security system may be configured to communicate with the computing assets through the local device using a TCP accelerated connection (e.g., as described herein with reference to FIG. 2). For example, the cloud-based security system may transmit and receive data through a TCP accelerated proxy of the cloud-based security system.

At block 358, the local device may be configured to transmit data between the cloud-based security system (e.g., a set of cloud-based scan engine(s)) and the computing asset(s). Thus, the local device may act as a proxy between the cloud-based security system and the computing asset(s). In some embodiments, the local device may be configured to transmit data between the cloud-based security system and the computing asset(s) using a TCP accelerated connection (e.g., as described herein with reference to FIG. 2). For example, the cloud-based security system may transmit and receive data through a TCP accelerated proxy of the local device. A set of cloud-based scan engine(s) may write data to a set of addresses (e.g., internet protocol (IP) addresses) designated for communicating with the local device.

At block 306D, the cloud-based security system may be configured to perform scanning operations therethrough to identify any cybersecurity issues and/or findings in the computing environment. Example scanning operations that may be performed by the cloud-based security system are described herein with reference to FIG. 1.

At block 308, the cloud-based security system may mitigate identified cybersecurity issue(s). Example actions that may be performed by the cloud-based security system to mitigate the identified cybersecurity issue(s) are described herein with reference to FIG. 1. As indicated by the dashed lines of block 308, in some embodiments, the cloud-based security system may not mitigate the identified cybersecurity issue(s). In such embodiments, the cloud-based security system may be configured to provide an indication of the cybersecurity issue(s) to a user associated with the computing environment (e.g., to cause the user to mitigate the identified issue(s)). In some embodiments, the cloud-based security system may indicate action(s) to mitigate the identified issue(s). In some embodiments, the cloud-based security system may be configured to trigger mitigation of the identified issue(s) by another system.

At block 360, the local device may be configured to perform one or more local mitigation operations. This mitigation of the identified issue(s), which may be alternatively phrased as handling the issue(s) or responding to findings, may comprise any of the appropriate actions described herein or any other suitable action. The local mitigation operation(s) may include, for example, denying a computing asset's access to a resource or application, causing the download or installation of software which impacts the functioning of computing assets, adjusting the security configurations of the computing environment, conducting additional scanning operations, generating a report of findings, and/or other operation(s).

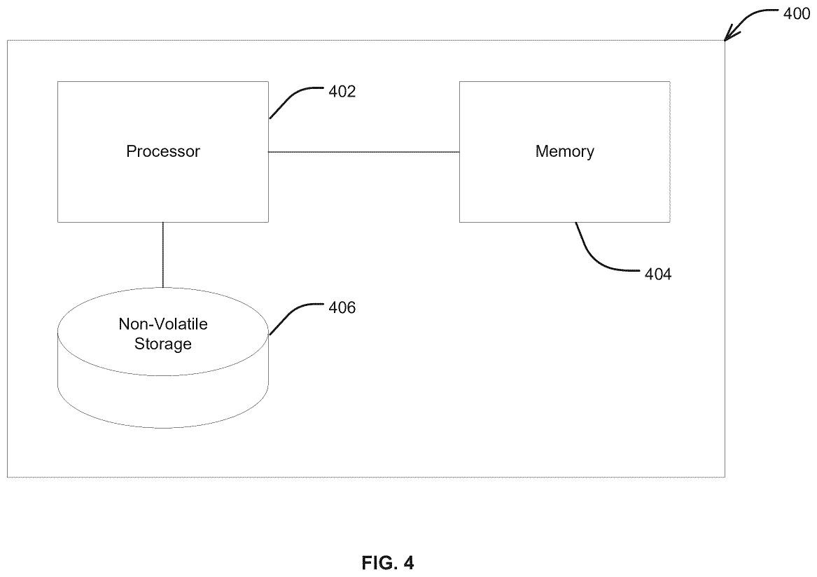

FIG. 4 is a block diagram of an exemplary computing device 400 that may be specially configured to implement some embodiments of the technology described herein. The computer system 400 may include one or more computer hardware processors 402 and non-transitory computer-readable storage media (e.g., memory 404 and one or more non-volatile storage 404). The processor(s) 402 may control writing data to and reading data from (1) the memory 404; and (2) the non-volatile storage device(s) 406. To perform any of the functionality described herein, the processor(s) 402 may execute one or more processor-executable instructions stored in one or more non-transitory computer-readable storage media (e.g., the memory 404), which may serve as non-transitory computer-readable storage media storing processor-executable instructions for execution by the processor(s) 402.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing,” “involving,” and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure, Accordingly, the foregoing description is by way of example only, and is not intended as limiting. The techniques are limited only as defined by the following claims and the equivalents thereto.

What is claimed is:

1. A system for performing scanning of a computing environment comprising a plurality of computing assets, the system comprising:
a first computing device in the computing environment, the first computing device configured to use a first scan engine support module to perform:
performing, using a first network mapping module, a first set of one or more network mapping operations on a first set of the plurality of computing assets in the computing environment to obtain a first set of network mapping data;
transmitting, to a cloud-based security system remote to the computing environment, the first set of network mapping data in support of scanning to be performed by the cloud-based security system; and
transmitting data between the cloud-based security system and the first set of computing assets in the computing environment; and
the cloud-based security system remote to the computing environment, the cloud-based security system configured to use a first set of one or more cloud-based scan engines to perform scanning of the computing environment by:
causing the first computing device to perform the first set of one or more network mapping operations on the first set of computing assets in the computing environment to obtain the first set of network mapping data; and
performing, using the first set of network mapping data, a first set of one or more scanning operations to identify a first cybersecurity issue or finding, the performing comprising communicating with the first set of computing assets in the computing environment through the first computing device.

2. The system of claim 1, wherein the first computing device is further configured to use the first scan engine support module to perform:
establishing a connection through which the first scan engine support module can communicate with the first set of one or more cloud-based scan engines, wherein the transmitting of the first set of network mapping data is performed using the connection.

3. The system of claim 2, wherein causing the first computing device to perform the first set of one or more network mapping operations on the first set of computing assets in the computing environment comprises:
transmitting, to the first network mapping module through the connection, at least one command, wherein the at least one command causes the network mapping module to:
perform the first set of one or more network mapping operations on the first set of computing assets in the computing environment to obtain the first set of network mapping data; and
transmit, to the first set of one or more cloud-based scan engines, the first set of network mapping data in support of scanning to be performed by the cloud-based security system.

4. The system of claim 3, wherein:
transmitting, to the first network mapping module, the at least one command comprises transmitting a plurality of commands; and
the first set of one or more cloud-based scan engines is configured to receive the first set of network mapping data responsive to the plurality of commands.

5. The system of claim 1, wherein the first computing device is further configured to use the first scan engine support module to perform:
establishing a first TCP accelerated proxy for transmission of data between the first set of computing assets and the first set of one or more cloud-based scan engines, wherein the transmitting of the data between the cloud-based security system and the first set of computing assets is performed using the first TCP accelerated proxy.

6. The system of claim 5, wherein establishing the first TCP accelerated proxy comprises:
establishing a connection between the first TCP accelerated proxy and a second TCP accelerated proxy associated with the first set of one or more cloud-based scan engines.

7. The system of claim 6, wherein communicating with the first set of computing assets in the computing environment through the first computing device comprises:
transmitting, through the connection between the first TCP accelerated proxy and the second TCP accelerated proxy, at least one request to the first set of computing assets; and
obtaining, through the connection between the first TCP accelerated proxy and the second TCP accelerated proxy, data in response to the at least one request.

8. The system of claim 1, wherein performing the first set of one or more scanning operations to identify the first cybersecurity issue or finding comprises:
determining, using data obtained from communicating with the first set of computing assets through the first computing device, whether a first vulnerability is present in the first set of computing assets.

9. The system of claim 1, wherein performing the first set of one or more scanning operations to identify the first cybersecurity issue or finding comprises:
determining, using data obtained from communicating with the first set of computing assets through the first computing device, whether the computing environment fails to comply with a policy.

10. The system of claim 1, further comprising:
a second computing device in the computing environment, the second computing device configured to use a second scan engine support module to perform:
performing, using a second network mapping module, a second set of one or more network mapping operations on a second set of the plurality of computing assets in the computing environment to obtain a second set of network mapping data;
transmitting, to the cloud-based security system, the second set of network mapping data in support of scanning to be performed by the cloud-based security system; and
transmitting data between the cloud-based security system and the second set of computing assets in the computing environment; and
wherein the cloud-based security system is further configured to use a second set of one or more cloud-based scan engines to perform scanning of the computing environment by:
causing the second computing device to perform the second set of one or more network mapping operations on the second set of computing assets in the computing environment to obtain the second set of network mapping data; and
performing, using the second set of network mapping data, a second set of one or more scanning operations to identify a second cybersecurity issue or finding, the performing comprising communicating with the second set of computing assets in the computing environment through the second computing device.

11. The system of claim 1, wherein the cloud-based security system is further configured to:
determine a number of cloud-based scan engines to instantiate to scan the computing environment for the first cybersecurity issue or finding; and
instantiate the determined number of cloud-based scan engines as the first set of one or more cloud-based scan engines.

12. The system of claim 11, wherein the cloud-based security system is further configured to determine the number of cloud-based scan engines to instantiate based on a number of computing assets in the first set of computing assets.

13. The system of claim 11, wherein the cloud-based security system is further configured to:
after instantiating the determined number of cloud-based scan engines as the first set of one or more cloud-based scan engines:
determine that one or more additional computing assets are to be scanned to obtain data; and
instantiate at least one additional cloud-based scan engine to be added to the first set when it is determined that the one or more additional computing assets are to be scanned.

14. The system of claim 1, wherein performing the first set of one or more network mapping operations comprises performing asset discovery to identify one or more assets in the first set of computing assets.

15. The system of claim 1, wherein performing the first set of one or more network mapping operations comprises performing service discovery to identify one or more services of the first set of computing assets.

16. A method for performing scanning of a computing environment comprising a plurality of computing assets, the method comprising:
using, by a first computing device in the computing environment, a first scan engine support module to perform:
performing, using a first network mapping module, a first set of one or more network mapping operations on a first set of the plurality of computing assets in the computing environment to obtain a first set of network mapping data;
transmitting, to a cloud-based security system remote to the computing environment, the first set of network mapping data in support of scanning to be performed by the cloud-based security system; and
transmitting data between the cloud-based security system and the first set of computing assets in the computing environment; and
using, by the cloud-based security system remote to the computing environment, a first set of one or more cloud-based scan engines to perform scanning of the computing environment by:
causing the first computing device to perform the first set of one or more network mapping operations on the first set of computing assets in the computing environment to obtain the first set of network mapping data; and
performing, using the first set of network mapping data, a first set of one or more scanning operations to identify a first cybersecurity issue or finding, the performing comprising communicating with the first set of computing assets in the computing environment through the first computing device.

17. The method of claim 16, further comprising using, by the first computing device, the first scan engine support module to perform:
establishing a connection through which the first scan engine support module can communicate with the first set of one or more cloud-based scan engines, wherein the transmitting of the first set of network mapping data is performed using the connection.

18. The method of claim 17, further comprising using, by the first computing device, the first scan engine support module to perform:
establishing a first TCP accelerated proxy for transmission of data between the first set of computing assets and the first set of one or more cloud-based scan engines, wherein the transmitting of the data between the cloud-based security system and the first set of computing assets is performed using the first TCP accelerated proxy.

19. The method of claim 18, wherein establishing the first TCP accelerated proxy comprises:
establishing a connection between the first TCP accelerated proxy and a second TCP accelerated proxy associated with the first set of one or more cloud-based scan engines.

20. At least one non-transitory computer-readable storage medium storing:
a first set of instructions that, when executed by a first computing device in a computing environment comprising a plurality of computing assets, cause the first computing device to perform:
performing, using a first network mapping module, a first set of one or more network mapping operations on a first set of the plurality of computing assets in the computing environment to obtain a first set of network mapping data;
transmitting, to a cloud-based security system remote to the computing environment, the first set of network mapping data in support of scanning to be performed by the cloud-based security system; and
transmitting data between the cloud-based security system and the first set of computing assets in the computing environment; and
a second set of instructions that, when executed by the cloud-based security system remote to the computing environment, cause the cloud-based security system to use a first set of one or more cloud-based scan engines to perform scanning of the computing environment by:
causing the first computing device to perform the first set of one or more network mapping operations on the first set of computing assets in the computing environment to obtain the first set of network mapping data; and
performing, using the first set of network mapping data, a first set of one or more scanning operations to identify a first cybersecurity issue or finding, the performing comprising communicating with the first set of computing assets in the computing environment through the first computing device.
